(19) United States
(12) Patent Application Publication
(10) Pub. No.: US 2007/0179819 A1
(43) Pub. Date: Aug. 2, 2007

(54) Integrated reservation and ticketing system

(76) Inventors: Jonathan C. Bradley, Nicholasville, KY (US); Hal Kolker, Boca Raton, FL (US)

Correspondence Address: Ketan S. Vakil, Esq.;SNELL & WILMER L.L.P., Suite 1400, 600 Anton Boulevard, Costa Mesa, CA, 92626-7689, US

(21) Appl. No.: 11/345,075

(22) Filed: Jan. 31, 2006

(51) Int. Cl. G06Q 10/00

(52) U.S. Cl. 705/5

(57) ABSTRACT

This invention is an apparatus and method that efficiently matches goods and service providers with consumers. The invention does this by taking inventory information from a provider and matching the goods or services in the inventory with individuals based on the individual's current geographic location and an individual's profile. The invention generates targeted advertisements for receipt on mobile devices. If an individual is interested in the good or service, the invention allows the individual to make a purchase completing the transaction.

### FIELD OF THE INVENTION

The invention relates generally to automated sales and reservation systems. More particularly, the invention relates to high volume, high speed sales systems and methods that targets consumers based on their geographic location, their subscriber profile, and their historic buying patterns.

### DESCRIPTION OF THE RELATED ART

Consumers are generally aware of sporting events, theatre performances, operas, concerts, and other events that require tickets in the geographic area in which they reside. They typically learn of these events through local newspapers, radio, television, the Internet, and other commercial media. If interested in purchasing tickets, the consumer may call the venue hosting the event or access their website to see if tickets are still available. The consumer may then purchase the tickets over the phone, through the venue's website, or at the box office located at the event.

Consumers may also be generally aware of restaurants, dinner theatres, spas, and other commercial service providers in their geographic area. Many of these providers require reservations or offer special deals and discounts. Consumers generally learn of these offers in an ad hoc fashion by perusing newspapers, the Internet or by “word of mouth.” At high demand times, some providers may require reservations, other providers may prefer reservations, and still others may not take them at all. High demand times are not necessarily obvious to consumers. A consumer may be able to infer that Friday and Saturday nights are high demand times for a trendy new downtown restaurant and that a reservation might be prudent. However, the consumer may not infer that reservations are required for a Tuesday 5:00 PM seating at a local Cincinnati restaurant on Pete Rose Way, if they are unaware the Reds are playing an evening game down the street.

Frequently providers will adjust the price of their goods and services based on a change in demand. For example, box offices may lower the price of tickets the night before a performance. However, consumers willing to purchase these “last minute” tickets are often unaware that they are even available. Even a consumers who is aware of the possibility of purchasing one of these “last minute” tickets must monitor the Internet, call the box office, or show up at a ticket sale location to find out if tickets are available.

Similarly, restaurants might offer discount meals or cocktails at certain hours to fill the seats in the restaurant. Additionally, movie theatres, spas, and other service providers may offer “come on” advertisements and sales to balance capacity with the fluctuating demand. Once again, consumers are often unaware of many of these opportunities available to them.

This dearth of information results in market inefficiencies. Some goods and services providers frequently lower their prices more than necessary because interested consumers are not aware of the availability. Traditional advertising methods might target consumers based on the demographic information of patrons of the advertising medium. However, such targeting of consumers is often imprecise. Frequently, the information is out of date when the consumer acts on the information. For example, the provider's inventory may sell out or an item of inventory may now be selling at a premium or a discount price.

Furthermore, business travelers and vacationers are often unaware of goods and services available to them. For instance, a Celtics fan on business travel to Sacramento may not realize the Celtics are playing the Kings at Arco Arena and that tickets are available for half the price it would cost to have seen the game in Boston. This situation creates a loss for the Celtics fan and a loss for the owners of Arco Arena. That is, the Celtics fan misses a game he could have attended and the Arco Arena has an empty non-revenue generating seat. Therefore, there exists a need in the art for systems and methods that targets consumers based on their geographic location, their subscriber profile, and their historic buying patterns.

### SUMMARY OF THE INVENTION

The invention solves many of the above stated problems by more efficiently matching providers with consumers. The invention does this by taking inventory information (e.g., available goods or services) from a provider and matching the inventory information with an individual subscriber based on the subscriber's current geographic location and/or the subscriber's profile.

The invention is characterized by three major functional components that manage a provider's inventory information, target advertising to a subscriber, and execute a transaction between the provider and the subscriber. These functions may be performed using a base station having multiple computer clusters that include a server coupled to multiple processors with access to a database. The computer clusters may be controlled by a master server that manages the activities of each of the computer clusters. The topology of the base station provides a high speed, fault tolerant computing platform for matching potential buyers (subscribers) with sellers (providers).

Inventory providers may specify an inventory by uploading to the base station information about the items (e.g., goods or services) in the inventory. The base station may search its databases for subscribers who might be interested in the items and are located geographically near the items. For example, a provider may upload a list of seat numbers, row numbers, prices, and a date for a block of unsold tickets to a Dodger baseball game. The base station would search its subscriber database for subscribers whose profiles indicate they may be interested in the tickets and are currently near Dodger Stadium or in the Los Angeles area.

The base station may then prioritize subscribers based on the probability of sale, historic buying patterns and other data. After prioritizing the list of potential purchasers, the base station may build targeted advertisements to the subscribers. The messages can then be sent to a subscriber's electronic device alerting them that an item they may be interested in is now available. The messages may contain details about the item such as seat number, row number, and price and instruction on how to purchase the item.

Subscribers who receive the advertisement may make an electronic offer to purchase the item from their electronic device. The base station may receive the electronic offer to purchase and if the item is still available will accept the offer for completing the sales transaction. After completing the transaction, the computer may notify the buyer (i.e., the subscriber) and the seller (i.e., the provider) of the sale.

### BRIEF DESCRIPTION OF THE DRAWINGS

FIG. 1 is a simplified block diagram of a ticket purchasing system illustrating the various features of an embodiment of the invention.

FIG. 2 is a block diagram illustrating the components and connections between the components of the ticket purchasing system according to an embodiment of the invention.

FIG. 3 is a flow diagram illustrating a method of inventory management according to an embodiment of the invention.

FIG. 4 is a flow diagram illustrating a method of subscriber profile management according to an embodiment of the invention.

FIG. 5 is a flow diagram illustrating a method of targeting advertisements to subscribers according to an embodiment of the invention.

FIG. 6 is a flow diagram illustrating a method of purchasing an item or making a reservation according to an embodiment of the invention.

### DESCRIPTION OF THE PREFERRED EMBODIMENTS

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

In the various embodiments, some structures and features are described as being embedded or part of another structure. The location of the structures and features for a particular embodiment are provided for clarity in understanding the invention. The invention embraces many embodiments that can be realized by rearranging the structures and features described. For example, the functionality described as being located on a single computer cluster in one embodiment may be co-hosted with another function on a different computer cluster.

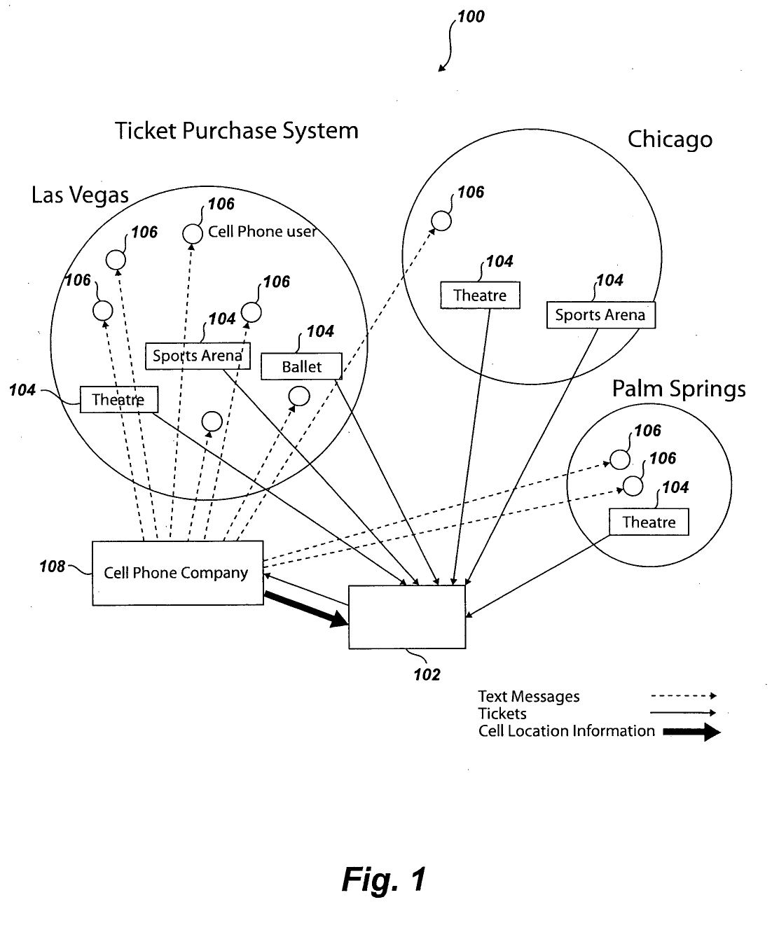

FIG. 1 is a simplified block diagram of a ticket purchasing system 100 illustrating the various features of an embodiment of the invention. The ticket purchasing system 100 may include a base station 102 that receives ticketing information from a number of venues 104. The base station 102 also receives geographic position information about the location of a number of mobile devices (e.g., cell phones) 106 that belong to a number of subscribers. The base station 102 may include one or more databases and may search these databases for subscribers who may be interested in purchasing tickets and who are located near the venues 104. The base station 102 then creates a message (e.g., a text message or an email) targeting those subscribers. The message may be sent to the subscriber's mobile device 106. The subscriber may then purchase a ticket using his/her mobile device 106.

For example, a theatre (the Venetian Theatre) in Las Vegas may have a few tickets available for the “Blue Man Group” show. The theatre box office may upload information about the theatre tickets to the base station 102. The base station 102 may search its databases for subscribers in the Las Vegas area who are interested in the “Blue Man Group” show or in live theatrical performances (the genre). The base station 102 may even search for subscribers who have previously purchased tickets to live performances in Las Vegas (e.g., at the Venetian) indicating historic buying patterns. The base station 102 may build a list of these subscribers in the databases and prioritize them based on probability of sales, historic buying patterns, and other criteria. The base station 102 may send a targeted advertisement to a subscriber's mobile device 106 that reads “Four orchestra seats, row 10, seats 9-12, available for the Blue Man Group show in Las Vegas, reply to this message if interested in purchasing the tickets.” The base station 102 may engage in a structured text dialog using wireless communications (e.g., a cellular phone system 108) that provides supplemental information (e.g., price, times, location) and allows the subscriber to make selections (e.g., how many seats, which seats). If the subscriber indicates he wishes to purchase the tickets, the base station 102 may verify the seats are still available and execute the transaction. The base station 102 may then send a confirmation number or ticket number to the subscriber and notify the Venetian Theatre that the tickets have been sold.

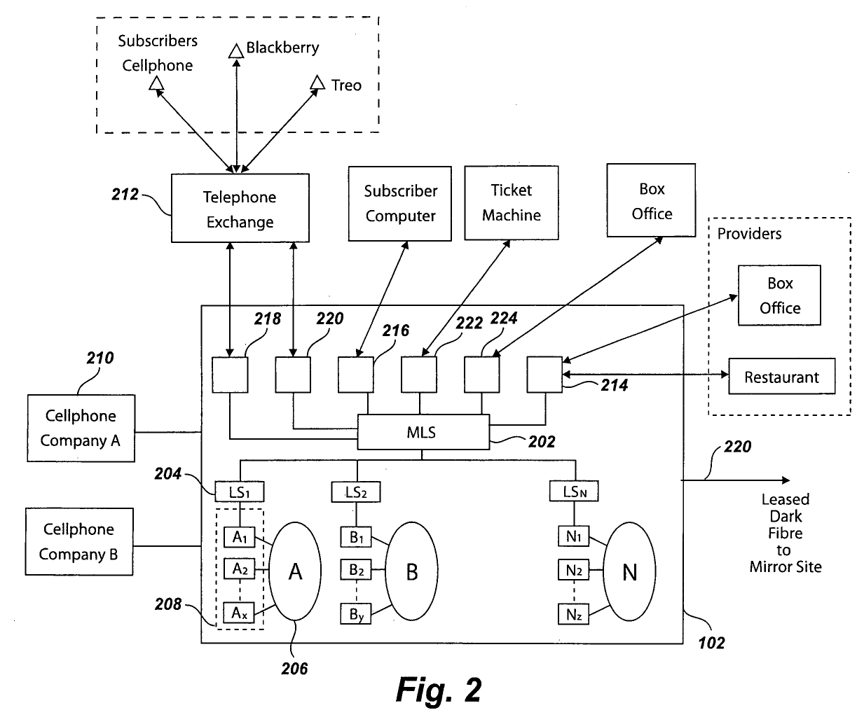

FIG. 2 is a block diagram illustrating the components and connections between the components of the ticket purchasing system 100 according to an embodiment of the invention. The base station 102 forms the hardware and software components of the invention. The base station 102 may be connected with multiple cell phone company servers and/or databases 210. Also, the base station 102 may be connected with a local telephone exchange 212 through an SMTP and POP3 server 218, or a touch tone and voice recognition server 220. Internet servers 214, 216, 222, 224 may connect the base station 102 to the Internet. A dark fiber connection 220 may connect the base station 102 to a sister site (e.g., a sister base station) (not shown).

The base station's 102 processing capability and databases may be mirrored at the sister site. The dark fiber connection 220 may virtually connect the sister site with the base station 102. In the event of a base station 102 system failure, the sister site may assume the operations of the base station 102 until the base station 102 is repaired, providing a redundant fail safe capability.

The base station 102 includes a master lockserver (MLS) 202 that controls the operations of one or more lockservers (LS) 204. Each lockserver 204 in turn controls one or more computers 208 with access to a corresponding database 206. The lockservers 204 may control the processes executed on each of the computers 208. The computers 208 may serve as gatekeepers for the databases 206. Also, the lockserver 204 may manage the individual failures of each of the computers 208 and corresponding databases 206. The computers 208 may have backup databases 206 and may have surplus computers allowing the lockserver 204 to workaround a failed computer or database. The lockserver 204 may notify the master lockserver 202 of any single point failures. An alert message, alarm, or report may be generated to alert base station 102 operators that there is a failure.

The master lockserver 202 and the lockservers 204 are computing platforms with locking software. The computing platform is preferably a high speed personal computer with at least one embedded Intel processor and a Windows or Linux operating system. Other embodiments may feature different processors, operating systems, and computing platforms. For example, the computing platform may be a Sun workstation with a UNIX operating system and a SPARC processor or an Apple Computer with an Apple O/S and a PowerPC processor.

There are also multiple suitable choices for the base station 102 (e.g., the computers 208 and the databases 206). A relational database such as mySQL hosted on a PC might be a suitable choice. Also, a Sybase or an Oracle database hosted on a UNIX platform may be a suitable choice.

One way of implementing the lockserver 204 is to have each of the computers 208 reports their status to the lockserver 204 every few seconds and request an assignment from the lockserver 204 if idle. If a computer 208 needs access to a record in the database 206, it first request permission from the lockserver 204. The lockserver 204 checks the “lock” status of the record. If the record is “locked,” the lockserver 204 denies the computer 208 access at that time. If the record is “unlocked,” the lockserver 204 changes the status of the record to “locked” and grants the computer 208 access to the database 206 at that time. The computer 208 may then access the record in the database 206. When the computer 208 has completed its access to the database 206, it reports to the lockserver 204 that it has completed access of the record. The lockserver 204 may then change the record status to “unlocked.”

The lockserver 204 may also maintain a queue of records to process. When idle, each computer 208 may query the lockserver 204 as to which record is next in the queue. The lockserver 204 may then change the status of the record to “locked” and grant the querying computer 208 the right to access the record. When the querying computer 208 is completed with the record, it report that it has finished with the record and the lockserver 204 changes the status of the record to “unlocked.”

The base station 102 may have access to the cell phone company server and/or database 210 to update its databases 206 with the current geographic position of the subscribers. The base station 102 may also query the cell phone company's servers and/or databases 210 to determine the type of cell phone or mobile device that a subscriber is using. This information may be important because advertising messages explained hereinafter may be tailored to the mobile device and targeted to users based on their geographic location.

The base station 102 may update its databases 206 with information from the cell phone company's servers and/or databases 210 at any suitable interval. Because of the large volume of information, the update should preferably occur at night or when the workload of the base station 102 is low. Access to the cell phone company's servers and/or databases 210 may be through any bridging protocol. An acceptable choice may Open DataBase Connectivity (ODBC).

The base station 102 may be connected with a variety of goods and services providers (providers) through a provider internet server 214. The internet server 214 may contain a variety of web applications that allow providers to enter information about their inventory. Providers may use the web applications to “pass” or “take back” inventory to and/or from the base station 102.

For instance a box office may wish to sell a block of unsold seats at ½ price on the day of the performance. The box office may access a web application available on the provider internet server 214. The web application may contain a form with cells to be populated by the provider with information about the ticket to be “passed” to the base station 102. The form may have cells for seat numbers, row number, price, time of the performance, or any other information that might influence a purchasing decision.

Other web applications may allow providers to enter recurring inventory to be passed to the base station 102. For example, a restaurant may have 20 reservation slots at 6:00 p.m. on every Friday evening and 30 reservations on every Thursday evening that it would like to fill. The web application may allow the restaurant to pass a month, a year or even perpetual inventory to the base station 102.

Web applications that enable entry of inventory may be fairly sophisticated. The applications may have embedded constraint checking and provide real time feedback as to whether the inventory item is an acceptable inventory item. They may also allow a flexible pricing schedule of the inventory item such as premium prices for sales between certain dates and discounted prices for sales between other dates. They may also allow providers to specify a start date and stop date for sales of items in the inventory.

Although inventory passed between a provider and the base station 102 may be passed through the Internet using web applications, the base station 102 may also contain other data communication systems for passing inventory such as telephone keypad entry, voice recognition software, email, etc. A customer service representative may also enter inventory.

The base station 102 may also feature a subscriber internet server 216 featuring web applications that allow potential subscribers to subscribe. The subscriber internet server 216 may also allow users to enter or update their declared interests. These interests may be stored in one of the base station's 102 databases 206 (the patron database). The declared interests may include specific interests as well as genre. For example, a subscriber may declare they are a Lakers' fan, a Pavarotti fan, and that they like Bertucci's Italian restaurant. The subscriber may also specify they enjoy sports, the opera and dining out at Italian restaurants. A subscriber's declared interests make up a part of a subscriber's profile.

The base station 102 may update the subscriber's profile with acquired information about each subscriber, such as the subscriber's current geographic location determined via the cell phone company database 210 or by the subscriber's historic buying patterns. The base station 102 may also add perceived interests to the subscriber's profile.

When an inventory item becomes available, the base station 102 may mine the patron database 206 searching for subscribers who might be potential customers. The base station 102 may compare individual subscriber profiles with the item of inventory and score the profiles based on many factors including probability of making a sale, subscriber profitability and proximity to the good or service. The base station 102 may then select the subscribers to target.

An item of inventory may be of interest to all subscribers in a geographic location. In this case, the base station 102 mines the patron's database for customers currently in the geographic location and selects all subscribers in that area to target. For example, a ticket to a world cup event or an Olympic sporting event may have such universal appeal that targeting subscribers solely on geographic location may be a good strategy.

The base station 102 may generate advertisements to send to subscribers. Advertisements may be sent in a variety of formats. The advertisement may be a simple text message transmitted to a subscriber's mobile device. The advertisement may be an email to a subscriber's email address. It may also be a pop up chat window. The advertisement may also be a voice message to a mobile device generated via a voice synthesizer. It may also appear as a menu tree on a mobile device. The advertisement may also be an HTML message transmitted to web enabled phones. The advertisement may be passive such as a web page or portion of a web page on one of the base station 102 servers.

A subscriber receiving a targeted advertisement may respond by requesting information or making an offer for purchase. Single line text devices may require a series of responses to narrowing questions to complete the offer. For example, the base station 102 may transmit a message such as Lakers tickets available tonight. Are you interested press 1 for Yes or 0 for No. If the user responds with a 1, the base station 100 may transmit a text message such as how many tickets are you interested in, followed by the # sign. A web enabled mobile device may receive the advertisement in the form of an HTML window that shows tickets, a seating chart, prices and all the information necessary for a subscriber to make a purchasing decision.

The subscriber may then make an offer to purchase. The offer to purchase may be made via the mobile device even though the advertisement was received on or through another device. A cell phone advertisement may allow the subscriber to make the offer to purchase by pressing a number or letter or entering a series of keystrokes on the keypad. If the advertisement is an HTML web page, the subscriber may be able to make the offer to purchase by clicking a button. The subscriber may respond to the message using a different medium. For example, a cell phone text message may have an advertisement that gives a web page address or a telephone number for purchasing the available item.

Offers to purchase may also be made without a targeted advertisement. A ticket machine may offer tickets in a point of sale transaction. The ticket machine may make the offer to purchase through the internet ticket server 222 in the base station 102. Box offices and other ticket outlets may make an offer to purchase tickets via web applications through an internet venue server 224 in the base station 102. Cell phone users may send a text message, use a star number, use a website or call a number and wait to make the offer to purchase. The base station 102 may respond with a “what are you interested in” message, menu tree, or HTML page for web enabled phones.

If the subscriber makes an offer to purchase, the base station 102 may verify that the inventory item is still available. If the item is available, the base station 102 may complete the transaction. A confirmation number, ticket number or similar message may be sent to the subscriber. The transaction confirmation may allow the subscriber to print out a paper ticket or may include instructions on how to get the ticket (e.g., will call). Some providers may accept presentation of a confirmation message as proof of purchase or proof of reservation.

The base station 102 may have the subscriber's credit or debit card number in its patron database or the user may have keyed the number into a cell phone or entered it via a keyboard. The base station 102 may then charge the user's card for the purchase. The base station 102 may notify the provider of the sale. Some providers may require immediate notification of sale while others may only desire a periodic report. The provider's preference may be specified in the inventory web application.

It should be noted there are many alternate embodiments of the topology of the base station 102. As in FIG. 2 the base station 102 may be divided into multiples computer clusters including the lockserver 204, the computers 208 and the databases 206. The lockserver 204 operations may be managed by a single master lockserver 202 that manages the processes of the individual lock servers 204, thus making the base station 102 a highly distributed, parallel, and fault tolerant system. However, the master lockserver 202, the lockservers 204, the computers 208, the databases 206, and servers in FIG. 2 can be rearranged in countless permutations. Thus, the topology in FIG. 2 is an exemplary embodiment.

One possible topology includes a master lock server 202 and seven computer clusters 208. The first computer cluster 208 may be a reader cluster that parses incoming text messages. The second computer cluster 208 may be a next activity cluster. The third computer cluster 208 may be a next menu writer. The fourth computer cluster 208 may be an email writer that formats an email with addresses for a pop-3 server. The fifth computer cluster 208 may be an order cluster that takes prices. The sixth computer cluster 208 may be a seat server cluster that manages seating information. The seventh computer cluster 208 may generate receipts for the provider or the subscriber.

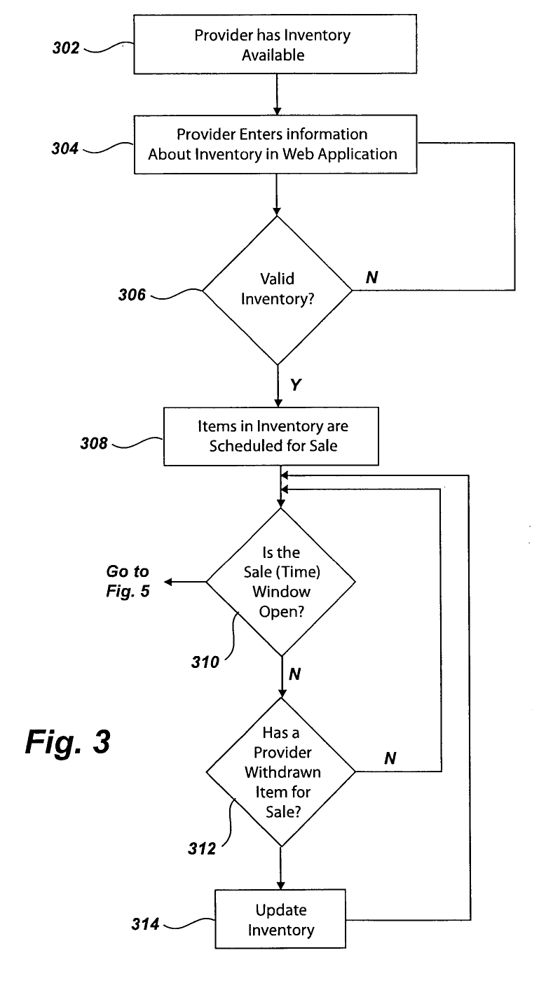

FIG. 3 is a flow diagram illustrating a method of inventory management according to an embodiment of the invention. In step 302, a provider determines that at least one item (inventory) is to be made available. Inventory may include tickets, reservations, or virtually any goods or services. The provider, in step 304, enters information about the inventory into a suitable web application. The information may include seat numbers, row numbers, price, dates and times or any other information about a good or service that a customer may want before making a purchasing decision. In step 306, the inventory is validated to determine if the items in the inventory may be sold. Validation may mean simple constraint checking (e.g., verifying ticket or reservation dates are in the future) or may be much more complex with many factors being used to determine whether the inventory or items in the inventory should be made available for sale. In step 308, the items are scheduled for sale. Items may be immediately available or they may become available at some future date. The information entered in step 304 may specify dates of sales. In step 310, the items in inventory are checked to see if any of them are currently available. If not, in step 312 the items in inventory are checked to see if the provider has chosen to withdraw an item in inventory or the entire inventory. If so, in step 314, the inventory is updated.

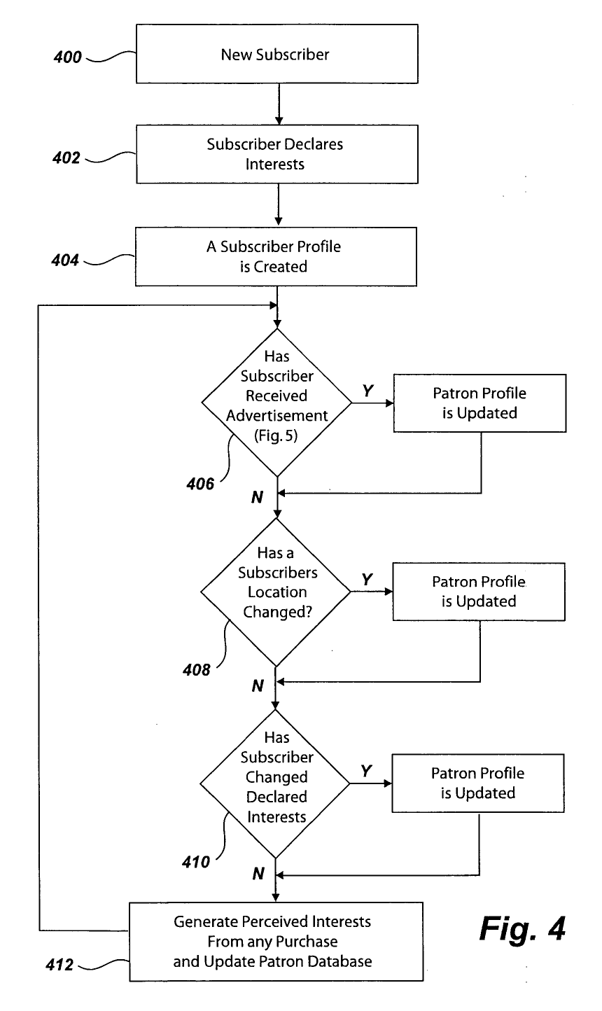

FIG. 4 is a flow diagram illustrating a method of subscriber profile management according to an embodiment of the invention. In step 400, a new subscriber is interested in subscribing to the service. In step 402, the subscriber declares his interests in a variety of goods and services. The interests may be very specific or may be a genre. The subscriber may declare his interest via a web application, over the phone, or on paper. In step 404, a subscriber profile is generated and placed in the patron database 206. The profile may include the subscribers' declared interests as well as other information acquired about the subscriber. In step 406, the base station 102 determines whether the subscriber has received any targeted advertisements. If so, the patron profile is updated. In step 408, the base station 102 determines whether the subscriber's location has changed. If so, the subscriber's profile is updated. In step 410, the base station 102 determines whether the subscriber has amended any of his declared interests. If so, the subscriber's profile is updated. In step 412, the base station 102 reviews the subscriber profile and generates perceived interests based on the information in the subscriber database 206.

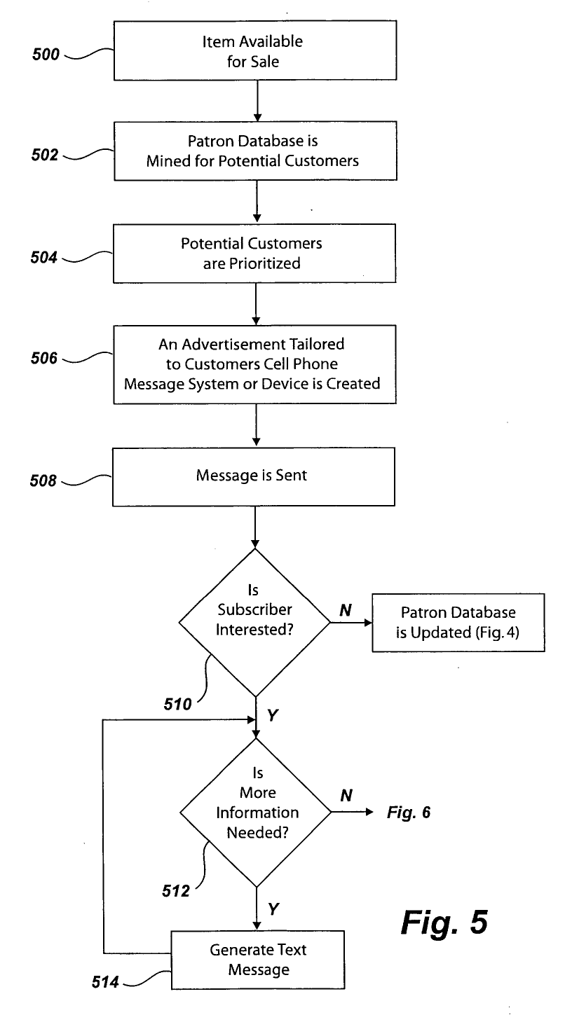

FIG. 5 is a flow diagram illustrating a method of targeting advertisements to subscribers according to an embodiment of the invention. In step 500, the base station 102 has an item of inventory for sale. In step 502, the patron database 206 is mined for potential customers. The subscriber profiles may be scored based on a variety of criteria including likelihood that they will purchase, declared interests, perceived interests, and historic buying patterns. In step 504, the potential subscribers are arranged or ordered based on their scores (e.g., highest to lowest scores). In step 506, targeted advertisements are created tailored to the individual subscriber's mobile device. In step 508, the messages are sent to the mobile devices. In step 510, the subscriber indicates if he/she is interested in the advertised merchandise. If so, the subscriber may indicate he/she needs more information. In step 512, the base station 102 determines if the subscriber indicated he/she needs more information. If so, in step 514, the base station 102 generates a text message with more information.

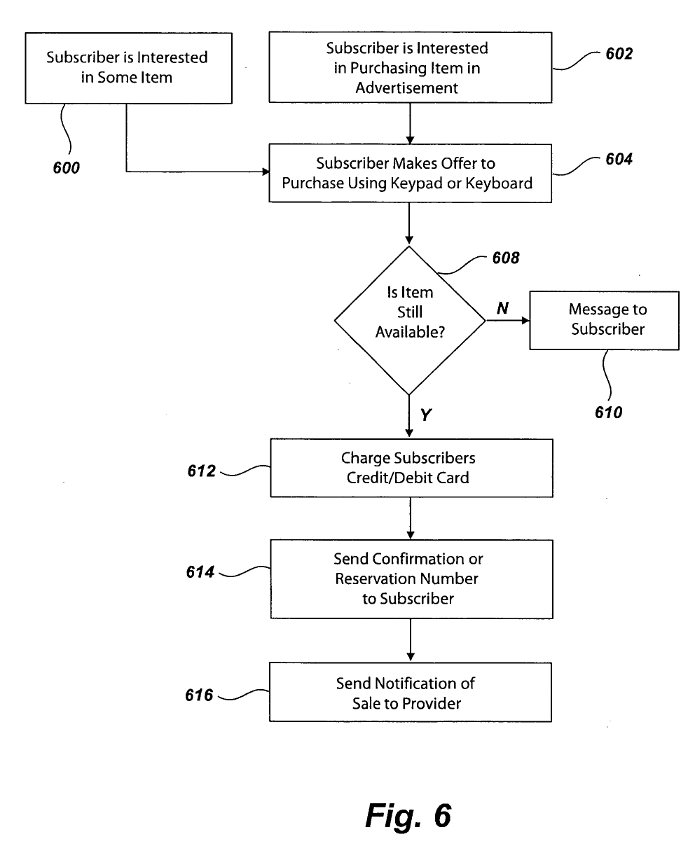

FIG. 6 is a flow diagram illustrating a method of purchasing an item or making a reservation according to an embodiment of the invention. In step 600, a subscriber is interested in purchasing an item or making a reservation. The subscriber may not even be sure the item is available. The subscriber may initiate contact with the base station 102 by calling a phone number, pressing a star number, using the Internet, or any other suitable communication method. Alternatively in step 602, the subscriber may have received a targeted advertisement from the base station 102 about an item he/she is now interested in. In step 604, the purchaser makes an offer to purchase. The purchaser may make the offer using a cell phone keypad, a cell phone menu tree, an HTML web page on a cell phone, a computer, or by voice using the telephone. In step 608, the base station 102 verifies that the item is still available. If the item is not available, the base station 102 sends a message to the subscriber indicating that the item is no longer available (step 610). If the item is available, the base station 102 charges the subscriber's credit/debit card (step 612). In step 614, the base station 102 sends a confirmation number, reservation number, or some other evidence of purchase to the subscriber's mobile device. In step 616, the base station 102 notifies the provider that the item has been sold.

What is claimed is:

1. A ticket and reservation brokering system comprising:
a base station including:
a plurality of computer clusters having a server, a plurality of computers and a database;
a master server that controls the activities of the servers in the plurality of computer clusters; and
an internet server connected with the master server;
a database bridge connected with at least one of the plurality of computer clusters for downloading area code or geographic position data; and
a telephone or data line connected with at least one server.

2. The ticket and reservation brokering system of claim 1 further comprising a pop3 and smtp server connected with the telephone or data line for generating and receiving messages.

3. The ticket and reservation brokering system of claim 1 wherein one of the databases contains subscriber information.

4. The ticket and reservation brokering system of claim 1 wherein one of the databases contains provider inventory information.

5. The ticket and reservation brokering system of claim 1 wherein one of the computers matches inventory information with subscribers.

6. A consumer and provider matching system comprising:
a database system including:
a master lock server;
a lockserver connected with the master lockserver;
a plurality of computers connected with the lockserver; and
a database connected with the plurality of computers;
an internet server connected with the database system;
a telephone or data line connected with the database system; and
a database bridge connected with the database system.

7. A consumer and provider matching system of claim 6 wherein the database is a relational database.

8. A consumer and provider matching system of claim 6 wherein the database bridge is an ODBC.

9. A consumer and provider matching system of claim 6 further comprising a mirror site connected via fiber.

10. A method for matching a provider with a consumer comprising:
receiving a declared interest profile from a subscriber;
storing the declared interest profile in a patron database;
receiving information about the subscriber's geographic location;
storing the subscriber's geographic location;
receiving information about an item from a provider;
searching the patron database for interested subscribers;
sending a message to the interested subscriber; and
receiving a response from the interested subscriber.

11. The method of claim 10 wherein the information about the subscribe's geographic location is the area code.

12. The method of claim 10 further wherein the message is tailored for a subscriber's electronic device.

13. The method of claim 10 further comprising the step of charging a subscribers credit card.

14. The method of claim 13 further comprising the step of sending a confirmation number to the subscriber.

15. The method of claim 10 further comprising the step of sending a report of sale to the provider.

16. A lockserver comprising:
a server;
a plurality of computers connected with the server;
a database connected with the plurality of computers;
wherein the server grants the computers access rights to individual records in the database.

17. The lockserver of claim 16 wherein the plurality of computers report status to the server at periodic intervals.

18. The lockserver of claim 16 wherein the database is a relational database.

19. The lockserver of claim 16 wherein the plurality of computers control access to the database.

20. The lockserver of claim 16 wherein each of the plurality of computers request access to the database.
